(19) United States
(12) Patent Application Publication
(10) Pub. No.: US 2025/0284724 A1
(43) Pub. Date: Sep. 11, 2025

(54) MULTI-STAGE SUMMARIZATION FOR CUSTOMIZED, CONTEXTUAL SUMMARIES

(71) Applicant: GOOGLE LLC, Mountain View, CA (US)

(72) Inventors: Ruofei Du, San Francisco, CA (US); Alex Olwal, Santa Cruz, CA (US); Vikas Bahirwani, San Francisco, CA (US); Susan Xu, San Francisco, CA (US)

(21) Appl. No.: 18/862,081

(22) PCT Filed: May 10, 2023
(86) PCT No.: PCT/US2023/021764

§ 371 Date: Oct. 31, 2024

Related U.S. Application Data
(60) Provisional application No. 63/364,478, filed on May 10, 2022.

(51) Int. Cl. G06F 16/34; G06F 40/30; G10L 15/26

(52) U.S. Cl. CPC G06F 16/345; G06F 40/30; G10L 15/26

(57) ABSTRACT

Described techniques including processing input text at a content type classifier machine learning (ML) model to obtain a content type of the input text. The input text and the content type may be processed at a content extractor ML model to obtain extracted content from the input text. The input text, the content type, and the extracted content may be processed at a summarizer ML model to obtain a summary of the input text.

### CROSS REFERENCE TO RELATED APPLICATIONS

This application claims the benefit of U.S. Provisional Application No. 63/364,478, filed May 10, 2022, the disclosure of which is incorporated herein by reference in its entirety.

This application also incorporates by reference herein the disclosures to related co-pending applications, U.S. application Ser. No. 18/315,113, filed May 10, 2023, “Multi-Stage Summarization for Customized, Contextual Summaries”, filed May 10, 2023 (Attorney Docket No. 0120-533WO1), “Dynamic Summary Adjustments for Live Summaries”, filed May 10, 2023 (Attorney Docket No. 0120-534WO1), “Summary Generation for Live Summaries with User and Device Customization”, filed May 10, 2023 (Attorney Docket No. 0120-535WO1), “Summarization with User Interface (UI) Stream Control and Actionable Information Extraction”, filed May 10, 2023 (Attorney Docket No. 0120-541WO1), and “Incremental Streaming for Live Summaries”, filed May 10, 2023 (Attorney Docket No. 0120-589WO1).

### TECHNICAL FIELD

This description relates to summarization using machine learning (ML) models.

### BACKGROUND

A volume of text, such as a document or an article, often includes content that is not useful to, or desired by, a consumer of the volume of text. Additionally, or alternatively, a user may not wish to devote time (or may not have sufficient time) to consume an entirety of a volume of text.

Summarization generally refers to techniques for attempting to reduce a volume of text to obtain a reduced text volume that retains most information of the volume of text within a summary. Accordingly, a user may consume information in a more efficient and desirable manner. In order to enable the necessary processing of the text, the latter may be represented by electronic data (text data). For example, a ML model may be trained to input text and output a summary of the text.

### SUMMARY

Described techniques process input text data to reduce a data volume of the input text data and obtain output text data expressing a summary of content of the input text data. The obtained, reduced volume of the output text data may be conformed to a size of a display, so as to optimize a size of the output text data relative to the size of the display. Moreover, described techniques may accomplish such customized data volume reductions with reduced delay, compared to existing techniques and approaches.

In a general aspect, a computer program product that is tangibly embodied on a non-transitory computer-readable storage medium includes that, when executed by at least one computing device, are configured to cause the at least one computing device to process input text at a content type classifier machine learning (ML) model to obtain a content type of the input text, process the input text and the content type at a content extractor ML model to obtain extracted content from the input text, and process the input text, the content type, and the extracted content at a summarizer ML model to obtain a summary of the input text.

According to another general aspect, a device includes at least one memory, at least one processor, at least one display, and a rendering engine. The rendering engine includes instructions stored using the at least one memory, which, when executed by the at least one processor, causes the device to process input text at a content type classifier machine learning (ML) model to obtain a content type of the input text, process the input text and the content type at a content extractor ML model to obtain extracted content from the input text, and process the input text, the content type, and the extracted content at a summarizer ML model to obtain a summary of the input text.

According to another general aspect, a method includes processing input text at a content type classifier machine learning (ML) model to obtain a content type of the input text, processing the input text and the content type at a content extractor ML model to obtain extracted content from the input text, and processing the input text, the content type, and the extracted content at a summarizer ML model to obtain a summary of the input text.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for multi-stage summarization for customized, contextual summaries.

FIG. 2 is a flowchart illustrating example operations of the system of FIG. 1.

FIG. 3 is a block diagram illustrating a more detailed example implementation of the system of FIG. 1.

FIG. 4 is a flowchart illustrating example training techniques for the example of FIG. 3.

FIG. 5 illustrates example scenario templates for use in the example of FIGS. 3 and 4.

FIG. 6 illustrates examples of input text, extracted content, and a resulting summary that is generated using the example of FIGS. 3 and 4.

FIG. 7 is a third person view of a user in an ambient computing environment.

FIGS. 8A and 8B illustrate front and rear views of an example implementation of a pair of smartglasses.

### DETAILED DESCRIPTION

Described systems and techniques enable accurate, customized, contextual summaries across a wide range of scenarios and use cases. Described techniques receive input text (input text data) and use at least one trained classifier to classify the input text, e.g., as relating to a content type and/or summary type (as data relating to content type and/or summary type). Then, based on the classified type(s), a trained content extractor may be used to extract relevant content from the input text. A trained summarizer model, e.g., a large language model (LLM), may then summarize the input text based on the classified type(s) and/or extracted content, to obtain a summary (output text data).

For example, a content type classifier may be trained to classify input text as relating to one of a plurality of scenarios, such as, e.g., a lecture, a set of instructions, or a conversation. That is, input text data may be processed by the content type classifier to obtain output text data specifying a pre-defined content type. A summary type classifier may be trained to classify the input text (input text data) as being associated with either an extractive summary type (e.g., in which only a subset of input text is permitted to be included in a summary, so that a subset of data is selected from input text data) or an abstractive summary type (e.g., in which words falling outside of the input text, such as a synonym or a paraphrasing, may be included in a summary, so that the input text data is reorganized, re-expressed, added, or replaced within the summary, along with an overall reduction in data volume between the input text and the abstractive summary). That is, input text data, perhaps in conjunction with the output text data of the summary type classifier, may be processed by the summary type classifier to obtain output text data specifying a pre-defined summary type. One or more content extractors may include a key content extractor or entity extractor, which may be designed to identify and extract, e.g., named entities or other key content from the input text. That is, input text data, perhaps in conjunction with the output text data of the content type classifier and/or the summary type classifier, may be processed by the content extractor to obtain output text data that includes key content, such as extracted entities.

The various classifier(s), extractor(s), and/or summarizer(s) may be implemented in a multi-stage, hierarchical, and/or waterfall architecture in which the input text (text data) is provided at each stage, and each stage subsequent to an initial stage receives an output (output text data) of at least one preceding stage. Accordingly, accurate summaries, e.g., expressed as output text data, may be generated in an efficient, customized manner.

Moreover, by providing textual inputs at each stage, each stage may be trained separately and independently of one another, without requiring a specific output type or specific output content from a preceding stage. As a result, each stage may be updated or expanded over time, without having to re-train other stages of the architecture.

In a more specific, simplified, and non-limiting example provided for the sake of illustration and explanation, input text may be classified as a lecture, and key content may be extracted from the input text, based on the lecture classification. Then, a summarizer may generate a summary that conforms to a lecture type template and that is structured based on the extracted key content. For example, a lecture on United States presidents may have presidents' names and years of election extracted for ordered inclusion in a resulting summary.

Described techniques may be implemented for virtually any type of input text, including, e.g., written or spoken input text. In the case of spoken input text (represented by audio data), automatic speech recognition (ASR) or other transcription techniques may be used to provide a live transcription, which may be provided to a user as a transcription stream (a stream of data). Then, described techniques may be used to simultaneously provide a corresponding live summarization stream (another stream of data), i.e., to provide the summarization stream in parallel with the transcription stream.

For example, a user wearing smartglasses or a smartwatch, or using a smartphone, may be provided with either/both a transcription stream and a summarization stream while listening to a speaker. In other examples, a user watching a video or participating in a video conference may be provided with either/both a transcription stream and a summarization stream.

Described techniques may be helpful, for example, when a user is deaf or heard of hearing, as the user may be provided with the summary stream visually on a display. Similarly, when the user is attempting to converse with a speaker in a foreign language, the user may be provided with the summary stream in the user's native language.

Described techniques thus overcome various shortcomings and deficiencies of existing summarization techniques, while also enabling new implementations and use cases. For example, existing summarization techniques may reduce input text excessively, may not reduce input text enough, may include irrelevant text, or may include inaccurate information. In scenarios in which a transcription stream and a summarization stream are desired to be provided in parallel, existing summarization techniques may be unable to generate a desirable summary quickly enough, or may attempt to generate summaries at inopportune times (e.g., before a speaker has finished discussing a topic).

In contrast, described techniques solve the above problems, and other problems, by, e.g., analyzing input text to characterize the type of text (e.g., a pre-determined scenario), determine the type of summary best-suited to use to summarize the text, and extract information (to be used as parameters) to constrain the resulting summary. Consequently, described techniques are well-suited to generate dynamic, real-time summaries, while a speaker is speaking, and in conjunction with a live transcription that is also produced and available to a user. As a result, the user may be provided with a fluid interaction with the speaker, while described techniques facilitate an understanding of the interaction by the user.

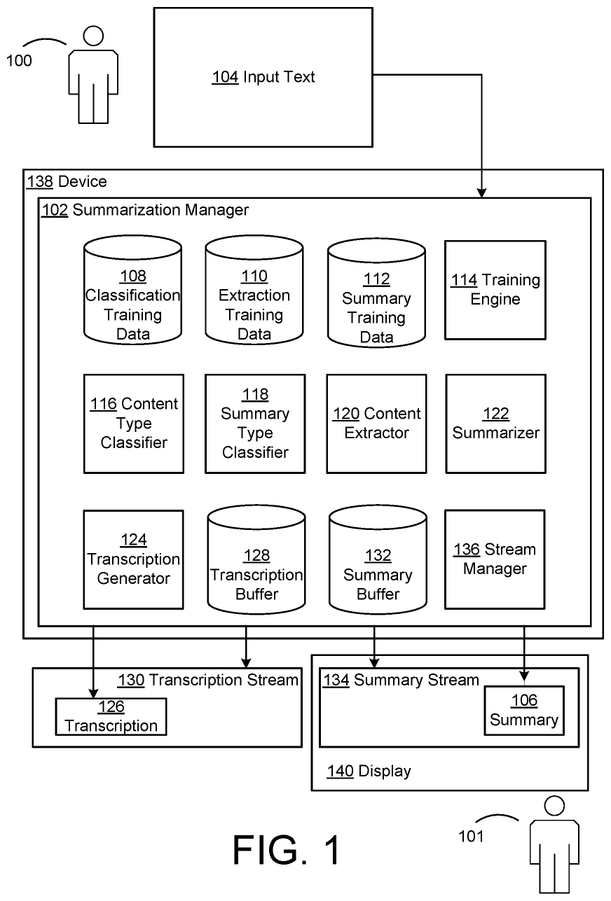

FIG. 1 is a block diagram of a system for multi-stage summarization for customized, contextual summaries. In the example of FIG. 1, a summarization manager 102 processes input text 104 to obtain a summary 106 (data representing a summary of the text data defining the input text). As referenced above, the input text 104 may include virtually any written or spoken/transcribed text. For example, the input text 104 may include a document, an article, a paper, a manuscript, an essay, an email, or any other written text. In other examples, the input text 104 may include any text transcribed from a lecture, a speech, a conversation, a dialogue, or any other spoken-word interaction of two or more participants.

In various included examples, the input text 104 may represent speech of a person referred to herein as a speaker 100, with the summary 106 being provided to a person referred to herein as a user 101. For example, a conversation may be conducted between the speaker 100 and the user 101, and the conversation may be facilitated by the summarization manager 102. In other examples, the speaker 100 may represent a lecturer, while the user 101 represents a lecture attendee, so that the summarization manager 102 facilitates a utility of the lecture to the user 101. The speaker 100 and the user 101 may be co-located and conducting an in-person conversation, or may be remote from one another and communicating via web conference. In other examples, the speaker 100 may record the input text 104 at a first time, and the user 101 may view (and receive the summary 106 of) the recorded audio and/or video at a later time.

FIG. 1 should thus be understood to illustrate an ability of the summarization manager 102 to provide the summary 106 in a stand-alone or static manner, in response to a discrete instance of the input text 104 (e.g., summarizing a single document or article, or summarizing audio of a single recorded video). At the same time, FIG. 1 also illustrates an ability of the summarization manager 102 to receive speech of the speaker 100 over a first time interval and output the summary 106 to the user 101, and then to repeat such speech-to-summary operations over a second and subsequent time interval(s) to provide the types of dynamic summarizations referenced above, and described in detail below with reference to a summary stream 134.

As also described in detail, below, the summarization manager 102 may be implemented in conjunction with any suitable device 138, such as a handheld computing device, smartglasses, earbuds, or smartwatch. For example, the summarization manager 102 may be implemented in conjunction with one or more such devices in which a microphone or other input device is used to receive the input text 104, and an audio output, visual display (e.g., a display 140 in FIG. 1), and/or other output device(s) is used to render or provide the summary 106.

The summarization manager 102 is illustrated in the simplified example of FIG. 1 as a single component that includes multiple sub-components. As also described below, however, the summarization manager 102 may be implemented using multiple devices in communication with one another.

As shown in FIG. 1, the summarization manager 102 may include or utilize classification training data 108, extraction training data 110, and summary training data 112, which may be processed by a training engine 114. For example, the training engine 114 may be configured to train and deploy a content type classifier 116 and/or a summary type classifier 118 using the classification training data 108, to train and deploy a content extractor 120 using the extraction training data, and/or to train and deploy a summarizer 122 using the summary training data 112.

In the present description, a classifier, such as the content type classifier 116 and the summary type classifier 118, refers generally to any trained model or algorithm that processes the input text 104, perhaps in conjunction with an output from at least one preceding classifier, to associate some or all of the input text 104 with at least one class of a plurality of pre-defined classes (of input text data). For example, the classification training data 108 may include known instances of training text that are each associated with a corresponding class label. Classifiers may be implemented, for example, as a naïve Bayesian classifier, decision tree classifier, neural network/deep learning classifier, or support vector machine, or any suitable classifier or combination of classifiers.

In the case of the content type classifier 116, the classification training data 108 may thus include many examples of training text that are each associated, for example, with scenario classes (of text data), where the scenarios may include, e.g., lectures, spatial directions, instructions, casual conversations, or any desired scenario class assigned as a label to corresponding training data within the classification training data 108.

In the case of the summary type classifier 118, the classification training data 108 may thus include many examples of training text that are each associated, for example, with summary type classes (of text data). As referenced above, summary type classes may include extractive summary types, abstractive summary types, or combinations/hybrids thereof.

A fully extractive summary type may require that all summary content within the summary 106 is contained within the input text 104. In a highly simplified example, the input text 104 may include statements such as “All participants are required to arrive by noon, and anyone arriving late may be prohibited from entering.” Then, an extractive summary may be generated as containing a subset such as “Participants are required to arrive by noon.” An abstractive summary may be generated that conveys the same information while potentially utilizing variations in terminology, such as “Those arriving after noon may not be allowed to enter.” An abstractive-extractive hybrid summary (which may also be referred to as an extractive-abstractive hybrid summary, or just as a hybrid summary) may thus have shared characteristics of extractive/abstractive summaries, such as, “Participants are required to arrive by noon, or they may not be allowed to enter.” Hybrid summaries may exist along a summary type scale ranging from exclusively/primarily extractive, to equally extractive/abstractive, to exclusively/primarily abstractive.

Further in the present description, an extractor, such as the content extractor 120, may represent any trained model or algorithm designed to identify and extract content that may be useful or important with respect to summary generation, based on the input text and on input from at least one preceding classifier. For example, such extracted content may include any type, category, or instance of information that may be structured in a known manner and/or that may be used to parameterize operations of the summarizer 122 in a desired manner. Any type of facts, phrases, or other key information may be identified for extraction. Some specific but non-limiting examples of such content may include, e.g., named entities, such as persons, things, dates, times, events, locations, or the like.

In the case of the content extractor 120, the extraction training data 110 may thus include many examples of training text from which various types and instances of content have been identified and associated as a label(s) that produces a desired summary result. For example, in the example text provided above of “All participants are required to arrive by noon, and anyone arriving late may be prohibited from entering,” extracted content may include “participants” and “noon.”

A summarizer, such as the summarizer 122, may represent any trained model or algorithm designed to perform summarization, in which input text data is processed to obtain output text data having a reduced volume. For example, the summarizer 122 may be implemented as a sequence-to-sequence generative large learning model (LLM).

In example implementations, the content type classifier 116, the summary type classifier 118, the content extractor 120, and the summarizer 122 may be trained independently, or may be trained together in groups of two or more. As referenced above, and described in more detail, below, training for each stage/model may be performed with respect to, e.g., input text representing examples of the input text 104, an input from at least one preceding stage, a ground truth output of the stage/model being trained, and a ground truth summary output of the summarizer 122.

For example, to train the content type classifier 116, the classification training data 108 may include training records that include training input text and a corresponding ground truth content type(s). The content type classifier 116 may thus be used to generate a generated content type from the training input text, which may be compared against the ground truth content type. For example, the ground truth content type may be obtained from earlier labeling of the training input text when the classification training data 108 is created.

When errors occur between the generated content type and the ground truth content type, a type and/or degree of the error may be used by the training engine 114 in a subsequent training iteration to adjust weights or other parameters of the content type classifier 116. Over multiple iterations, the weights or other parameters may thus be adjusted by the training engine 114 to cause the content type classifier 116, once deployed, to process the input text 104 and generate a corresponding content type (e.g., scenario type), with an acceptable level of accuracy.

Similar comments apply to training of the summary type classifier 118, the content extractor 120, and the summarizer 122. For example, for training the summary type classifier 118, the classification training data 108 may include summary type labels, such as extractive, abstractive, and hybrid, representing ground truth summary types.

Then, the summary type classifier 118 may be trained, for example, by processing training input text to generate a generated summary type, which may be compared against the ground truth summary type for that training input text to determine any corresponding errors. Determined errors may then be used to adjust weights/parameters of the summary type classifier 118.

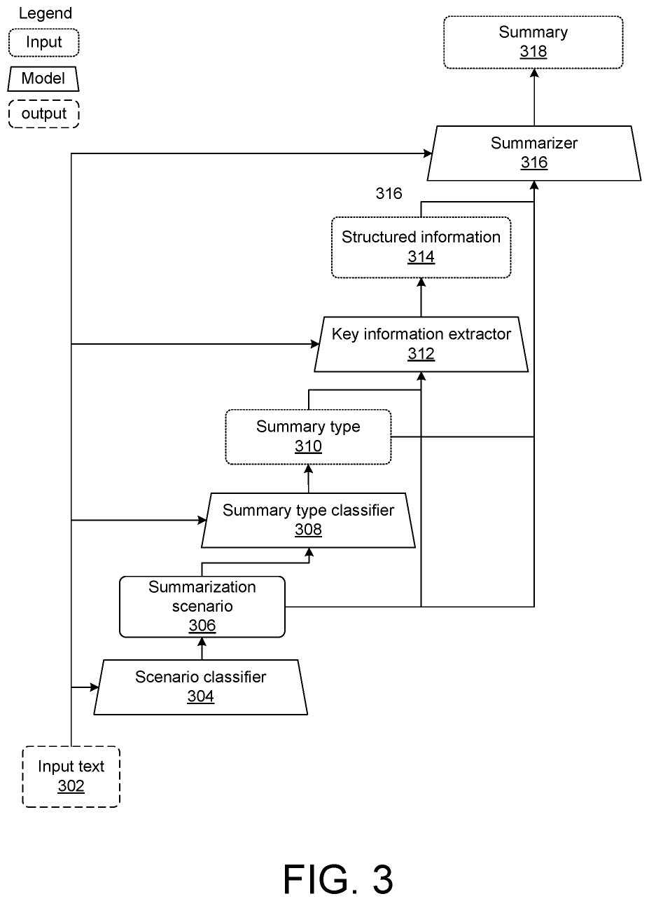

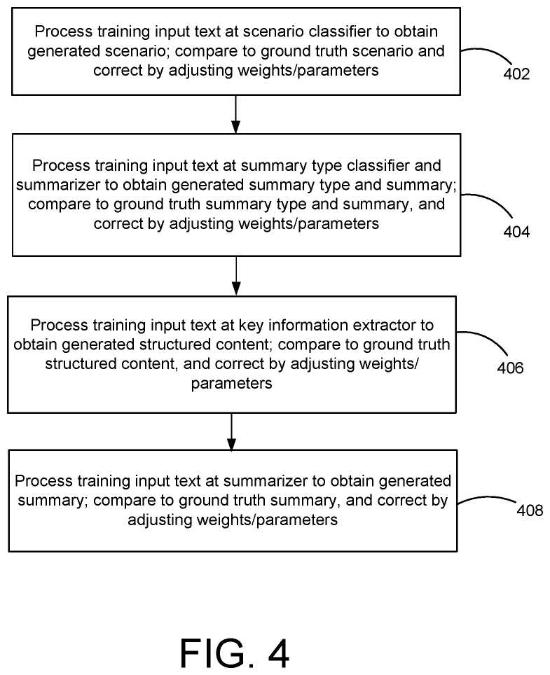

As described in more detail, below, with respect to FIGS. 3 and 4, the summary type classifier 118 may also input the content type(s) output by the content type classifier 116. In such implementations, the training engine 114 may train the summary type classifier 118 using both training input text and training content types, with generated summary types again being compared against ground truth summary types, as already described.

The content extractor 120 may be trained using training input text, as well as either or both of outputs of the summary type classifier 118 and/or the content type classifier 116. The summarizer 122 may be trained using training input text, as well as one or more of outputs of the content extractor 120, the summary type classifier 118, and/or the content type classifier 116.

Thus, any of the summarizer 122, the content extractor 120, the summary type classifier 118, or the content type classifier 116 may be trained individually/independently, or two or more of the summarizer 122, the content extractor 120, the summary type classifier 118, or the content type classifier 116 may be trained jointly. Additional or alternative implementations of the summarization manager 102 are provided below, including additional or alternative training techniques.

Consequently, as referenced above, and illustrated and described below, e.g., with respect to FIG. 3, the summarizer 122, the content extractor 120, the summary type classifier 118, or the content type classifier 116 may be trained and deployed in a number of different architectures. For example, the content type classifier 116 may input the input text 104 and output a content type that is input, along with the input text 104, by the summary type classifier 118. The content extractor 120 may input a summary type from the summary type classifier 118 along with the input text 104 and the classified content type, and output extracted content. The summarizer 122 may input the extracted content, the summary type, and the content type, along with the input text 104, and output the summary.

In example implementations, the above-referenced inputs of the input text 104, the content type, the summary type, and the extracted content may all be represented textually (e.g., by text data). Similarly, the above-referenced outputs of content type, summary type, extracted content, and summary, may all be represented textually. Textual representations of inputs/outputs facilitate independent training of the summarizer 122, the content extractor 120, the summary type classifier 118, and/or the content type classifier 116. Moreover, such textual representations of inputs/outputs facilitate expansion of one or more of the summarizer 122, the content extractor 120, the summary type classifier 118, or the content type classifier 116, such as when a new content type is added for recognition by the content type classifier 116.

For example, the content type classifier 116 may be trained to output text (represented by text data), such as ‘lecture,’ ‘directions,’ or ‘conversation,’ rather than, e.g., an internal classification scheme such as ‘class 1,’ ‘class 2,’ or ‘class 3.’ The summary type classifier 118 may be trained using the textual output classes, without requiring characterization of any such internal classification scheme. As a result, the summary type classifier 118 may be trained independently of training of the content type classifier 116. Moreover, a fourth content type, such as ‘instructions’, may be added to the available classes of the content type classifier 116, so that the content type classifier 116 and the summary type classifier 118 may have incremental training updates focused on such a new content type classifier, without having to entirely re-train one or both of the content type classifier 116 or the summary type classifier 118.

In specific examples, such textual inputs may be concatenated and fed to a subsequent stage/model. For example, the input text 104 and a generated content type of the content type classifier 116 may be concatenated and fed to the summary type classifier 118. More generally, any two or more textual inputs may be concatenated into concatenated textual input and processed to obtain a corresponding output.

Many other implementations are possible. For example, in contrast to the above examples, outputs may be defined in terms of knowledge graph representations, rather than textually. Additionally, as referenced, two or more of the summarizer 122, the content extractor 120, the summary type classifier 118, or the content type classifier 116 may be trained jointly, e.g., using such knowledge graph representations, or other output schemes. Still further, additional or alternative models may be used, e.g., additional or alternative classifiers may be used, and one or more of the summarizer 122, the content extractor 120, the summary type classifier 118, or the content type classifier 116 may be modified or omitted. For example, the summary type classifier 118 may be omitted, and the content type classifier 116 may output content types directly to the content extractor 120.

As referenced above, the input text 104 may include written text (text data), e.g., a document, or an article, or may include spoken words (audio data). When the input text 104 includes spoken words, a transcription generator 124 may be configured to convert the spoken words (audio data) to transcribed text, shown in FIG. 1 as a transcription 126. For example, the transcription generator 124 may include an automatic speech recognition (ASR) engine or a speech-to-text (STT) engine.

The transcription generator 124 may include many different approaches to generating text, including additional processing of the generated text. For example, the transcription generator 124 may provide timestamps for generated text, a confidence level in generated text, and inferred punctuation of the generated text. For example, the transcription generator 124 may also utilize natural language understanding (NLU) and/or natural language processing (NLP) models, or related techniques, to identify semantic information (e.g., sentences or phrases), identify a topic, or otherwise provide metadata for the generated text.

The transcription generator 124 may provide various other types of information in conjunction with transcribed text, perhaps utilizing related hardware/software. For example, the transcription generator 124 may analyze an input audio stream to distinguish between different speakers, or to characterize a duration, pitch, speed, or volume of input audio, or other audio characteristics.

Thus, the transcription 126 may represent an entirety of transcribed audio, such as a transcribed lecture, and may include, or provide access to, one or more of the types of data and/or metadata just referenced. For example, transcription generator 124 may receive an audio file of a recorded lecture and output the transcription 126. In such examples, the transcription 126 may be used as input text to one or more of the content type classifier 116, the summary type classifier 118, the content extractor 120, and/or the summarizer 122.

In other examples, the transcription generator 124 may utilize a transcription buffer 128 to output a transcription stream 130. That is, for example, rather than processing an entirety of an audio file, the transcription generator 124 may process a live conversation, discussion, or other speech, in real time and while the speech is happening.

For example, while the speaker 100 is speaking, the transcription generator 124 may output transcribed text to be stored in the transcription buffer 128. The transcribed text may be designated as intermediate or final text within the transcription buffer 128, before being available as the transcription stream 130 (a stream of data). For example, the transcription generator 124 may detect the end of a sentence, a switch in speakers, a pause of pre-defined length, or other detected audio characteristic to designate a final transcription to be included in the transcription stream 130. In other examples, the transcription generator 124 may wait until the end of a defined time interval to designate a final transcription of audio.

The transcription stream 130 may thus be fed as input text 104 and processed, e.g., as described above, to populate a summary buffer 132 and output a summary stream 134 (another stream of data), e.g., a stream of summary captions. A stream manager 136 may be configured to manage various characteristics of the summary stream 134, relative to, or in conjunction with, the transcription stream 130.

For example, the stream manager 136 may be configured to parameterize or otherwise control operations of the summarizer 122 in populating the summary buffer 132. For example, the stream manager 136 may cause the summarizer 122 to control a compression ratio of summarized text to input text, or to increase or decrease a complexity of summarized text. For example, the stream manager 136 may configure operations of the summarizer 122 to control the summary stream 134 based on, e.g., user preferences, characteristics of a speaker of the audio being transcribed, or device/display characteristics of a device used to display the summary stream 134.

In other examples, the stream manager 136 may utilize characteristics of the transcription stream 130 to determine whether or when to invoke the summarizer 122. For example, the stream manager 136 may detect sentence endings, pauses in speech, or a rate (or other characteristic) of the audio to determine whether/when to invoke the summarizer 122.

In further examples, the stream manager 136 may be configured to control various display characteristics with which the transcription stream 130 and/or the summary stream 134 are provided. For example, the stream manager 136 may provide the user 101 with an option to view either or both (e.g., toggle between) the transcription stream 130 and the summary stream 134

The stream manager 136 may also be configured to display various indicators related to the transcription stream 130 and the summary stream 134. For example, the stream manager 136 may display a summarization indicator that informs the user 101 that a current portion of the summary stream 134 is being generated, while the summarizer 122 is processing a corresponding portion of the transcription stream 130.

The stream manager 136 may also control a size, spacing, font, format, and/or speed (e.g., scrolling speed) of the transcription stream 130 and the summary stream 134. Additionally, the stream manager 136 may provide additional processing of the summary stream 134. For example, the stream manager 136 may identify and extract actionable content within the summary stream 134, such as calendar items, emails, or phone calls. In some implementations, the stream manager 136 may be configured to facilitate or enact corresponding actions, such as generating a calendar item, or sending an email or text message, based on content of the summary stream 134.

Although the transcription buffer 128 and the summary buffer 132 are described herein as memories used to provide short-term storage of, respectively, the transcription stream 130 and the summary stream 134, it will be appreciated that the same or other suitable memory may be used for longer-term storage of some or all of the transcription stream 130 and the summary stream 134. For example, the user 101 may wish to capture a summary of a lecture that the user 101 attends for later review. In these or similar situations, multiple instances or versions of the summary 106 may be provided, and the user 101 may be provided with an ability to select a most-desired summary for long term storage.

In FIG. 1, the transcription stream 130 is shown separately from the summary stream 134, and from the display 140. However, as noted above, the transcription stream 130 may be displayed on the display concurrently with, or instead of, the summary stream 134. Moreover, the transcription stream 130 and the summary stream 134 may be implemented as a single (e.g., interwoven) stream of captions. That is, for example, the transcription stream 130 may be displayed for a period of time, and then a summary request may be received via the input device 142, and a corresponding summary (e.g., the summary 106) may be generated and displayed. Put another way, an output stream of the display 140 may alternate between displaying the transcription stream 130 and the summary stream 134.

The various sub-components 108-136 are each illustrated in the singular in FIG. 1, but should be understood to represent at least one instance of each sub-component. For example, two or more training engines, represented by the training engine 114, may be used to implement the various types of training used to train and deploy the content type classifier 116, the summary type content classifier 118, the content extractor 120, and/or the summarizer 122.

In FIG. 1, the summarization manager 102 is illustrated as being implemented and executed using a device 138. For example, the device 138 may represent a handheld computing device, such as a smartphone, or a wearable computing device, such as smartglasses, smart earbuds, or a smartwatch.

The device 138 may also represent cloud or network resources in communication with a local device, such as one or more of the devices just referenced. For example, the various types of training data and the training engine 114 may be implemented remotely from the user 101 operating a local device, while a remainder of the illustrated components of the summarization manager are implemented at one or more of the local devices.

The summary 106 and/or the summary stream 134 are illustrated as being output to a display 140. For example, the display 140 may be a display of the device 138, or may represent a display of a separate device(s) that is in communication with the device 138. For example, the device 138 may represent a smartphone, and the display 140 may be a display of the smartphone itself, or of smartglasses or a smartwatch worn by the user 101 and in wireless communication with the device 138.

In FIG. 1, the transcription stream 130 is shown separately from the summary stream 134, and from the display 140. However, as noted above, the transcription stream 130 may be displayed on the display concurrently with, or instead of, the summary stream 134. Moreover, the transcription stream 130 and the summary stream 134 may be implemented as a single (e.g., interwoven) stream of captions. That is, for example, the transcription stream 130 may be displayed for a period of time, and then a summary request may be received via the input device 142, and a corresponding summary (e.g., the summary 106) may be generated and displayed. Put another way, an output stream of the display 140 may alternate between displaying the transcription stream 130 and the summary stream 134.

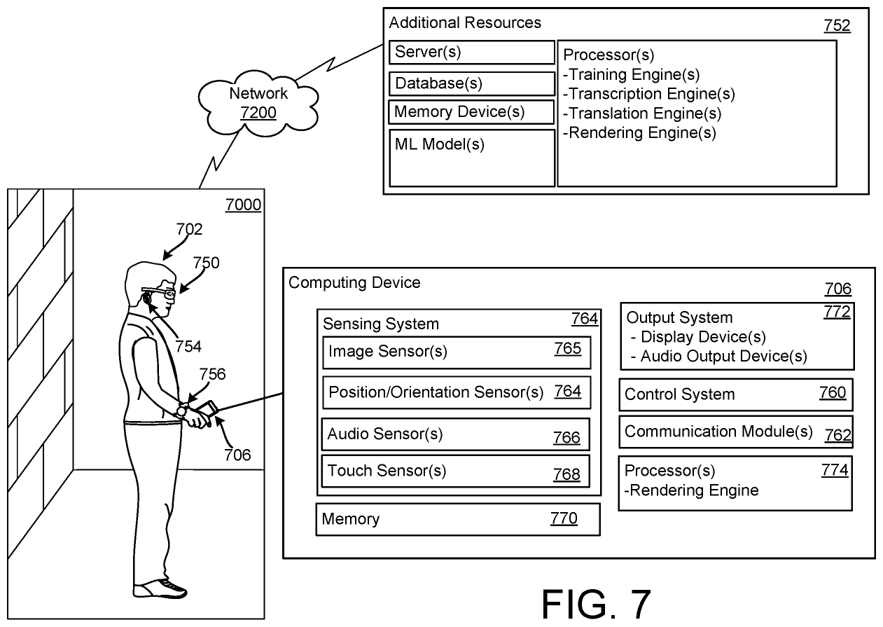

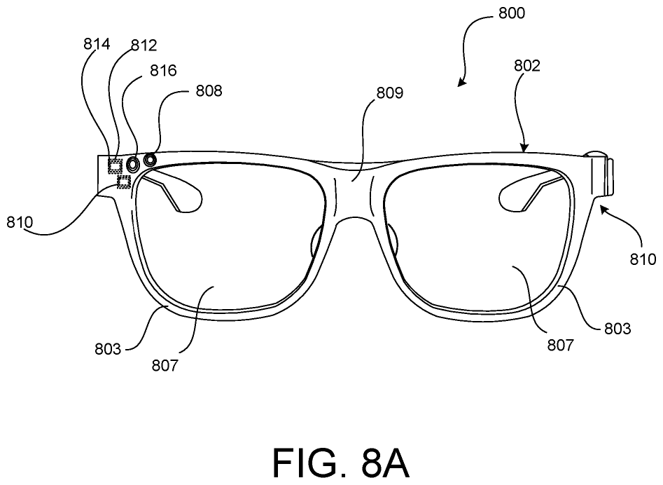

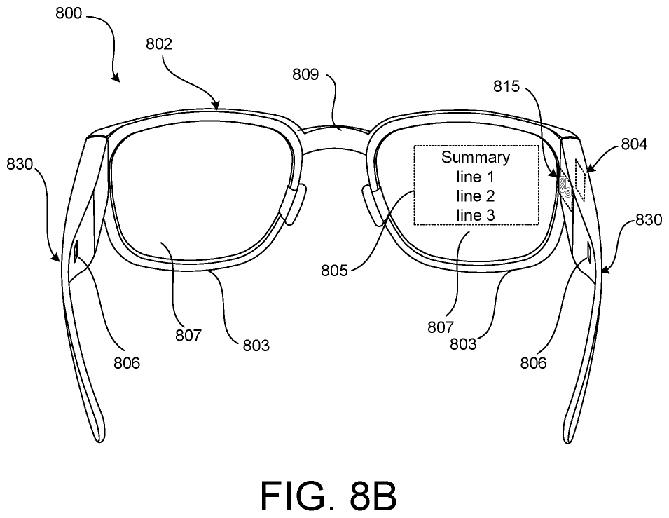

More detailed examples of devices, displays, and network architectures are provided below, e.g., with respect to FIGS. 7, 8A, and 8B. In addition, the summary 106 and the summary stream 134 (as well as the transcription 126 and the transcription stream 130) may be output via audio, e.g., using the types of smart earbuds referenced above.

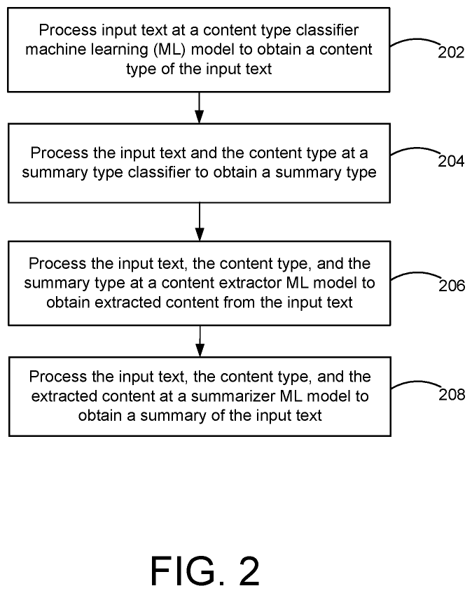

FIG. 2 is a flowchart illustrating example operations of the system of FIG. 1. In the example of FIG. 2, operations 202-208 are illustrated as separate, sequential operations. However, in various example implementations, the operations 202-208 may be implemented in a different order than illustrated, in an overlapping or parallel manner, and/or in a nested, iterative, looped, or branched fashion. Further, various operations or sub-operations may be included, omitted, or substituted.

In FIG. 2, the input text 104 may be processed at the content type classifier 116 to obtain a content type of the input text (202). For example, the input text 104 may include text data obtained from converting audio data such as the speech 104, e.g., representing spoken conversation, into text data. For example, the content type may be one of a plurality of content types representing types of scenarios, such as lecture, directions, instructions, or conversation. The output content type may be expressed textually.

The input text 104 and the content type may be processed at the summary type classifier 118 to obtain a summary type (204). For example, the summary type may be one of a known number of classes, such as extractive, abstractive, and hybrid. In such cases, as referenced, the summary types may be output in textual form. In other examples, the summary type may be classified along a continuous or sliding scale, such as a value between 0 and 1, where 0 represents the extractive summary type, 1 represents the abstractive summary type, and intervening values represent summary types between those two extremes. In such cases, the summary types may be output in numeric form. Put another way, the summary type may be classified numerically within a summary type range between extractive and abstractive summary types.

The input text, the content type, and the summary type may be processed at the content extractor 120 to obtain extracted content from the input text (206). For example, the content extractor 120 may obtain any key information that may have been determined during earlier training by the training engine 114 to produce desired summaries from the summarizer 122. Such key information may include, but is not limited to, key phrases and/or named entities. The extracted content may be provided in textual form (by text data).

Then, the input text 104, the content type, the summary type, and the extracted content may be processed at the summarizer 122 to obtain the summary 106 of the input text 104 (208). For example, the summarizer 122 may output an extractive summary of scenario type ‘instructions,’ with extracted content including ordering information for the instructions, such as ‘first,’ ‘second,’ and ‘third.’ In other examples, the summarizer 122 may output an abstractive summary of scenario type ‘lecture,’ with abstracted summary content including paraphrases of the lecture topic(s).

As noted above, one or more operations of FIG. 2 may be omitted or modified. For example, the summary type classifier 118 may be omitted, and the output content type (e.g., scenario) from the content type classifier 116 may be provided directly to the content extractor 120. In other examples, other types of input classifiers may be used, in addition to, or in place of, one or both of the content type classifier 116 and the summary type classifier 118.

FIG. 3 is a block diagram illustrating a more detailed example implementation of the system of FIG. 1. FIG. 3 illustrates an example implementation with a cascading, multi-stage, waterfall-style architecture, in which each stage informs the next, and ultimately leads to the generation of pertinent and informative summaries.

As shown, input text 302 is received at a first stage that includes a scenario classifier 304, representing an example of the content type classifier 116 of FIG. 1. For example, the scenario classifier 304 may be trained and configured to classify the input text 302 as being a summarization scenario 306, such as a lecture, a set of instructions, spatial directions, or a casual conversation.

The summarization scenario 306 thus provides a textual representation of available scenarios, and may be provided as input to a subsequent stage(s), such as to a summary type classifier 308. As referenced above, one benefit of designing the architecture of FIG. 3 with textual representations as inputs/outputs is that some or all of the included ML models, such as the scenario classifier 304, may be scaled to include more scenarios, without changes to downstream models, as such models may also be designed to accept text as input.

For example, a casual conversation may be summarized with a high-level synopsis of its content, while users might prefer a detailed summary of a lecture. Summarizing instructions may require identifying action items and deadlines from the input, while summarizing directions to a new place may benefit from retaining information about landmarks, in addition to the instructions for how to get to the destination.

Described techniques provide fluid, dynamic, real-time summaries of the above and other scenarios, potentially across multiple scenarios that may occur consecutively or in succession. For example, a student attending a lecture of a professor may first receive one or more summaries classified as belong to lecture scenarios. Then, the professor may finish the lecture and provide instructions for out-of-class work, which may be summarized based on a detected instructions scenario. Then, the student may have a conversation with the professor, which may be summarized based on a detected conversation scenario.

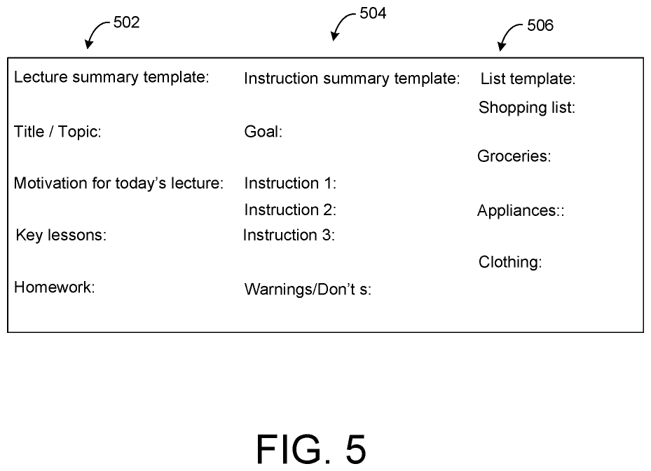

Multiple options may be used for representing the summarization scenario 306 using text. For example, textual representations may include, but are not limited to, a scenario name (e.g., lecture, instructions, spatial directions, conversations, or the like), a scenario description, a scenario-specific summary template, or combinations of these and other textual representations. For example, a scenario-specific summary template may dictate a format and/or types of content of a resulting summary, as illustrated and described in more detail, below, with respect to FIG. 5.

Then, given the input text 302 and the summarization scenario 306, a summary type classifier 308 may be trained to classify a summary 318 to be generated as having a summary type 310 such as extractive, abstractive, or a hybrid. For example, if the summarization scenario 306 is determined to be an instructions scenario, the summary type 310 may be extractive. If, however, the input text 302 contains superfluous details, a more abstractive summary type may be designated. For example, instructions such as airport announcements may be classified as extractive.

The resulting summary type 310 may also be represented textually for downstream consumption. In other examples, however, the summary type 310 may be represented using a sliding scale, such as a range between 0 and 1. For example, a fully extractive summary may be designated as having a 0 value, while a fully abstractive summary may be designated as having a 1 value, with hybrid summary types falling along a sliding scale between 0 and 1.

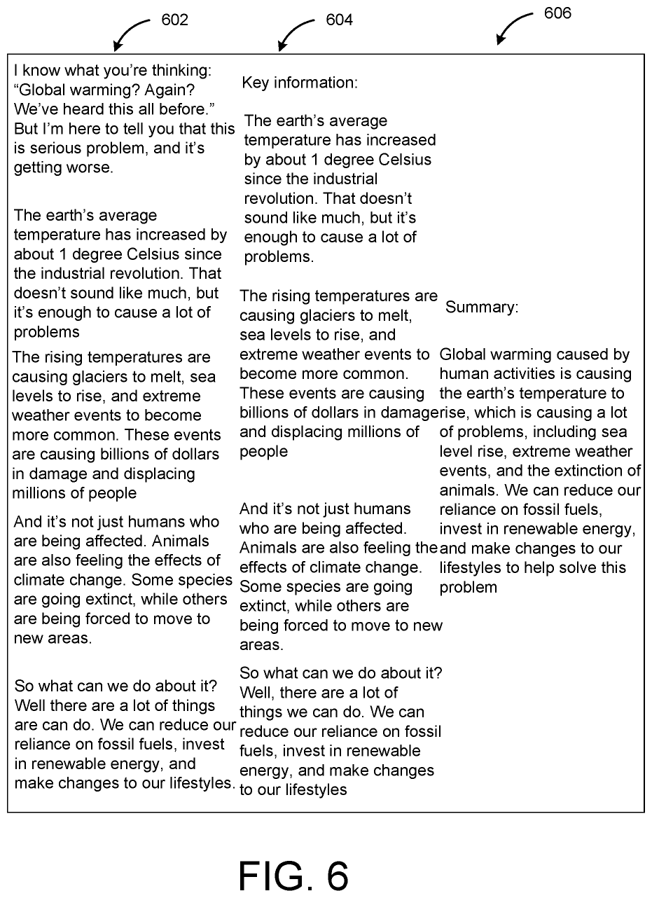

A key information extractor 312 may represent an example of the content extractor 120 of FIG. 1. In general, an informative and high-quality summary may be required or desired to contain most or all of the key information in the input. A type and content of such key information, however, may be contingent on the type of the summarization scenario 306. For instance, when summarizing a lecture about global warming, such as in the example of FIG. 6, below, greetings between the speaker and the user may not be important. In other examples, such as when summarizing instructions, the how-to of achieving the goal of the instructions may be more important than the why of achieving the instructions' goal.

Thus, the key information extractor 312 may be configured to extract structured information 314 that may include, e.g., named entities, key phrases, or any content which the key information extractor 312 has been trained to recognize as being useful or important for the corresponding summary type 310 and summarization scenario 306.

Key information may also be influenced by topics included in the input text 302. For example, as referenced above and shown/described with respect to FIG. 6, a topic of ‘global warming’ may dictate or influence which included content is considered to be key content to be extracted by the key information extractor 312. If the input text 302 contains a number of topics, then top-N topics may be identified to be included as a part of the summary 318 to be generated by a summarizer 316, and information pertinent to those topics may be extracted by the key information extractor 312. As described with respect to the input text 302, the summarization scenario 306, and the summary type 310, the structured information 314 may be represented as a sequence of text, for easy consumption by the summarizer 316.

Accordingly, the summarizer 316 may be implemented as a sequence-to-sequence (seq-to-seq) generation model, which takes the input text 302, the summarization scenario 306, the summary type 310, and the structured information 314, and outputs the summary 318. As mentioned above, the input text 302, the summarization scenario 306, the summary type 310, and the structured information 314 may all be represented as text, and, e.g., concatenated together to form the total input for the summarizer 316. The summarizer 316 may thus be responsible for converting received textual input into useful internal representations, which then may be used to generate high quality summaries, such as the summary 318.

FIG. 4 is a flowchart illustrating example training techniques for the example of FIG. 3. In the example of FIG. 4, training input text may be processed at the scenario classifier 304 to obtain a generated scenario, which may be compared to a known, ground truth scenario to enable adjustments and other corrections of weights/parameters of the scenario classifier 304 (402). For example, the training engine 114 of FIG. 1 may utilize the classification training data 108 when training the scenario classifier 304 as an example of the content type classifier 116.

For example, for training data such as a known lecture that is labeled as such, the scenario classifier 304 may initially and incorrectly output a scenario of ‘directions.’ Back propagation and error minimization techniques may be used to adjust weights/parameters of the scenario classifier 304 to make it more likely that a next iteration of training will result in a correct (or at least a less wrong) classification by the scenario classifier 304. Over many such iterations, the scenario classifier 304 will become more and more accurate at classifying scenarios.

For example, a scenario labeled lecture may be expected to produce a detailed summary, whereas instructions may be focused on only those portions of input text associated with accomplishing a corresponding goal. A scenario for spatial directions may have a summary that identifies landmarks or relative distances, whereas a casual conversation scenario may primarily track topics being discussed, without going into full details of the topics.

Further in FIG. 4, training input text may be processed at the summary type classifier 308 and the summarizer 316 to obtain a generated summary type and summary, which may be compared to a known, ground truth summary type and summary to enable adjustments and other corrections of weights/parameters of the summary type classifier 308 and of the summarizer 316 (404). In other words, in the example of FIG. 4, the summary type classifier 308 and the summarizer 316 may be trained jointly, rather than independently. In this way, for example, the summary type classifier 308 may be trained to classify summary types along the type of sliding scale referenced above (e.g., between 0 and 1), rather than using a finite subset of classes, such as extractive, abstractive, and hybrid. In other example implementations, however, the summary type classifier 308 may be trained independently, by matching generated outputs of the summary type classifier with each of a defined subset of canonical labels, such as abstractive, extractive, and hybrid.

Training of a score as just described, as compared to training using canonical labels, may be considered or implemented as using the score of a preceding stage (e.g., the summary type classifier 308) as an internal representation of a subsequent stage (e.g., the summarizer 316). Thus, during training, the summary type classifier 308 might produce a specific score between 0 and 1, e.g., .4, which might be used by the summarizer 316 during training to generate a summary. The generated summary may then be compared to the ground truth summary, and differences therebetween may be captured numerically and back-propagated to make any adjustments to the generated summary type score. For example, in a subsequent iteration, a same or similar input training data at the summary type classifier 308 might produce a different summary type score, e.g., .5, which might then result in a summary that more closely matches a corresponding ground truth summary.

Training input text may be processed at the key information extractor 312 to obtain generated key information, which may be compared to known, ground truth key information to enable adjustments and other corrections of weights/parameters of the key information extractor 312 (406). For example, training data may include training input text, scenario labels, and/or summary type labels, and the key information extractor 312 may generate key information to be compared against ground truth key information.

Finally in FIG. 4, training input text may be processed at the summarizer 316 to obtain a generated summary, which may be compared to a known, ground truth summary to enable adjustments and other corrections of weights/parameters of the summarizer (408). For example, for the example of FIG. 3, training data may include training input text, scenario labels, summary type labels, and/or key information, and the summarizer 316 may generate a summary to be compared against a corresponding ground truth summary.

In alternative example implementations, any two or more of the scenario classifier 304, the summary type classifier 308, the key information extractor 312, and/or the summarizer 316 may be trained jointly. For example, it is possible to train the entire system of FIG. 3 together in a cohesive way, with each stage being trained using training data generated by a preceding stage(s).

FIG. 5 illustrates example scenario templates for use in the example of FIGS. 3 and 4. FIG. 5 illustrates a lecture summary template 502, an instruction summary template 504, and a list template 506.

For example, as shown, the lecture summary template 502 may specify a title/topic, a lecture motivation, key lessons, and homework. The instruction summary template 504 may identify a goal and first/second/third instructions, as well as warnings and/or actions to avoid. The list template 506 may specify a type of list, such as shopping list, such as for groceries, appliances, or clothing.

The simplified examples of FIG. 5 illustrate that the scenario classifier 304 of FIG. 3, or the content type classifier 116 of FIG. 1, may be configured to associate a template with each corresponding scenario. Each such template may be expressed in a textual format. Then, subsequent stages, such as the summary type classifier 308, the key information extractor 312, and/or the summarizer 316, may be configured to make corresponding determinations (e.g., classifications, extractions, and/or summarizations) that conform to the relevant scenario template.

FIG. 6 illustrates examples of input text, extracted content, and a resulting summary that is generated using the example of FIGS. 3 and 4. FIG. 6 includes a first column 602 that represents input text 302 of FIG. 3. For example, the column 602 may represent an instance of the transcription stream 130, which may be captured from spoken audio using the transcription generator 124 of FIG. 1.

FIG. 6 illustrates an example of key information extracted by the content extractor 120 of FIG. 1, or the key information extractor 312 of FIG. 3. As shown, the key information of the column 604 may contain entire phrases/sentences extracted from the input/transcription of the column 602.

Finally in FIG. 6, the column 606 includes a summary determined using at least the input/transcription of the column 602 and the key information of the column 604. As described, the summary of the column 606 may also be determined using a determined scenario classification and/or summary type classification.

In examples in which the input of the column 602 represents transcribed audio, the column 602 may be understood to provide an example of the transcription stream 130 of FIG. 1, while the summary of column 606 may be understood to represent an example of the summary stream 134 of FIG. 1. Further details and examples us the use of transcription streams and summary streams are provided below, in the context of FIGS. 7 and 8.

FIG. 7 is a third person view of a user 702 (analogous to the user 101 of FIG. 1) in an ambient environment 7000, with one or more external computing systems shown as additional resources 752 that are accessible to the user 702 via a network 7200. FIG. 7 illustrates numerous different wearable devices that are operable by the user 702 on one or more body parts of the user 702, including a first wearable device 750 in the form of glasses worn on the head of the user, a second wearable device 754 in the form of ear buds worn in one or both ears of the user 702, a third wearable device 756 in the form of a watch worn on the wrist of the user, and a computing device 706 held by the user 702. In FIG. 7, the computing device 706 is illustrated as a handheld computing device, but may also be understood to represent any personal computing device, such as a table or personal computer.

In some examples, the first wearable device 750 is in the form of a pair of smart glasses including, for example, a display, one or more images sensors that can capture images of the ambient environment, audio input/output devices, user input capability, computing/processing capability and the like. Additional examples of the first wearable device 750 are provided below, with respect to FIGS. 8A and 8B.

In some examples, the second wearable device 754 is in the form of an ear worn computing device such as headphones, or earbuds, that can include audio input/output capability, an image sensor that can capture images of the ambient environment 7000, computing/processing capability, user input capability and the like. In some examples, the third wearable device 756 is in the form of a smart watch or smart band that includes, for example, a display, an image sensor that can capture images of the ambient environment, audio input/output capability, computing/processing capability, user input capability and the like. In some examples, the handheld computing device 706 can include a display, one or more image sensors that can capture images of the ambient environment, audio input/output capability, computing/processing capability, user input capability, and the like, such as in a smartphone. In some examples, the example wearable devices 750, 754, 756 and the example handheld computing device 706 can communicate with each other and/or with external computing system(s) 752 to exchange information, to receive and transmit input and/or output, and the like. The principles to be described herein may be applied to other types of wearable devices not specifically shown in FIG. 7 or described herein.

The user 702 may choose to use any one or more of the devices 706, 750, 754, or 756, perhaps in conjunction with the external resources 752, to implement any of the implementations described above with respect to FIGS. 1-6. For example, the user 702 may use an application executing on the device 706 and/or the smartglasses 750 to receive, transcribe, and display the transcription stream 130 of FIG. 1 and/or the summary stream 134 of FIG. 1.

As referenced above, the device 706 may access the additional resources 752 to facilitate the various summarization techniques described herein, or related techniques. In some examples, the additional resources 752 may be partially or completely available locally on the device 706. In some examples, some of the additional resources 752 may be available locally on the device 706, and some of the additional resources 752 may be available to the device 706 via the network 7200. As shown, the additional resources 752 may include, for example, server computer systems, processors, databases, memory storage, and the like. In some examples, the processor(s) may include training engine(s), transcription engine(s), translation engine(s), rendering engine(s), and other such processors. In some examples, the additional resources may include ML model(s), such as the various ML models of the architectures of FIGS. 1 and/or 3.

The device 706 may operate under the control of a control system 760. The device 706 can communicate with one or more external devices, either directly (via wired and/or wireless communication), or via the network 7200. In some examples, the one or more external devices may include various ones of the illustrated wearable computing devices 750, 754, 756, another mobile computing device similar to the device 706, and the like. In some implementations, the device 706 includes a communication module 762 to facilitate external communication. In some implementations, the device 706 includes a sensing system 764 including various sensing system components. The sensing system components may include, for example, one or more image sensors 765, one or more position/orientation sensor(s) 764 (including for example, an inertial measurement unit, an accelerometer, a gyroscope, a magnetometer and other such sensors), one or more audio sensors 766 that can detect audio input, one or more touch input sensors 768 that can detect touch inputs, and other such sensors. The device 706 can include more, or fewer, sensing devices and/or combinations of sensing devices.

Captured still and/or moving images may be displayed by a display device of an output system 772, and/or transmitted externally via a communication module 762 and the network 7200, and/or stored in a memory 770 of the device 706. The device 706 may include one or more processor(s) 774. The processors 774 may include various modules or engines configured to perform various functions. In some examples, the processor(s) 774 may include, e.g, training engine(s), transcription engine(s), translation engine(s), rendering engine(s), and other such processors. The processor(s) 774 may be formed in a substrate configured to execute one or more machine executable instructions or pieces of software, firmware, or a combination thereof. The processor(s) 774 can be semiconductor-based including semiconductor material that can perform digital logic. The memory 770 may include any type of storage device or non-transitory computer-readable storage medium that stores information in a format that can be read and/or executed by the processor(s) 774. The memory 770 may store applications and modules that, when executed by the processor(s) 774, perform certain operations. In some examples, the applications and modules may be stored in an external storage device and loaded into the memory 770.

Although not shown separately in FIG. 7, it will be appreciated that the various resources of the computing device 706 may be implemented in whole or in part within one or more of various wearable devices, including the illustrated smartglasses 750, earbuds 754, and smartwatch 756, which may be in communication with one another to provide the various features and functions described herein. For example, the memory 770 may be used to implement the transcription buffer 128 and the summary buffer 132.

In FIG. 7, any audio and/or video output may be used to provide the types of summaries described herein, and associated features. For example, described techniques may be implemented in any product in which improving speech-to-text would be helpful and in which high-quality summaries would be beneficial. Beyond head-worn displays, wearables, and mobile devices, described techniques may be used in remote conferencing and web apps (including, e.g., providing captions/summaries within web-conferencing software and/or pre-recorded videos).

Described techniques may also be useful in conjunction with translation capabilities, e.g., of the additional resources 752. For example, the user 702 may listen to a conversation from a separate speaker (corresponding to the speaker 100 of FIG. 1), who may be proximate to, or removed from, the user 702), where the speaker may be speaking in a first language. A translation engine of the processors of the additional resources 752 may provide automated translation of the dialogue into a native language of the user 702, and also may summarize the translated dialogue using techniques described herein.

The architecture of FIG. 7 may be used to implement or access one or more large language models (LLMs), which may be used to implement a summarizer for use in the preceding examples. For example, the Pathways Language Model (PaLM) and/or the Language Model for Dialogue Application (LaMDA), both provided by Google, Inc., may be used.

An example head mounted wearable device 800 in the form of a pair of smart glasses is shown in FIGS. 8A and 8B, for purposes of discussion and illustration. The example head mounted wearable device 800 includes a frame 802 having rim portions 803 surrounding glass portion, or lenses 807, and arm portions 830 coupled to a respective rim portion 803. In some examples, the lenses 807 may be corrective/prescription lenses. In some examples, the lenses 807 may be glass portions that do not necessarily incorporate corrective/prescription parameters. A bridge portion 809 may connect the rim portions 803 of the frame 802. In the example shown in FIGS. 8A and 8B, the wearable device 800 is in the form of a pair of smart glasses, or augmented reality glasses, simply for purposes of discussion and illustration.

In some examples, the wearable device 800 includes a display device 804 that can output visual content, for example, at an output coupler providing a visual display area 805, so that the visual content is visible to the user. In the example shown in FIGS. 8A and 8B, the display device 804 is provided in one of the two arm portions 830, simply for purposes of discussion and illustration. Display devices 804 may be provided in each of the two arm portions 830 to provide for binocular output of content. In some examples, the display device 804 may be a see through near eye display. In some examples, the display device 804 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 807, next to content (for example, digital images, user interface elements, virtual content, and the like) output by the display device 804. In some implementations, waveguide optics may be used to depict content on the display device 804.

The example wearable device 800, in the form of smart glasses as shown in FIGS. 8A and 8B, includes one or more of an audio output device 806 (such as, for example, one or more speakers), an illumination device 808, a sensing system 810, a control system 812, at least one processor 814, and an outward facing image sensor 816 (for example, a camera). In some examples, the sensing system 810 may include various sensing devices and the control system 812 may include various control system devices including, for example, the at least one processor 814 operably coupled to the components of the control system 812. In some examples, the control system 812 may include a communication module providing for communication and exchange of information between the wearable device 800 and other external devices. In some examples, the head mounted wearable device 800 includes a gaze tracking device 815 to detect and track eye gaze direction and movement. Data captured by the gaze tracking device 815 may be processed to detect and track gaze direction and movement as a user input. In the example shown in FIGS. 8A and 8B, the gaze tracking device 815 is provided in one of two arm portions 830, simply for purposes of discussion and illustration. In the example arrangement shown in FIGS. 8A and 8B, the gaze tracking device 815 is provided in the same arm portion 830 as the display device 804, so that user eye gaze can be tracked not only with respect to objects in the physical environment, but also with respect to the content output for display by the display device 804. In some examples, gaze tracking devices 815 may be provided in each of the two arm portions 830 to provide for gaze tracking of each of the two eyes of the user. In some examples, display devices 804 may be provided in each of the two arm portions 830 to provide for binocular display of visual content.

The wearable device 800 is illustrated as glasses, such as smartglasses, augmented reality (AR) glasses, or virtual reality (VR) glasses. More generally, the wearable device 800 may represent any head-mounted device (HMD), including, e.g., a hat, helmet, or headband. Even more generally, the wearable device 800 and the computing device 706 may represent any wearable device(s), handheld computing device(s), or combinations thereof.

Use of the wearable device 800, and similar wearable or handheld devices such as those shown in FIG. 7, enables useful and convenient use case scenarios of implementations of the systems of FIGS. 1-4. For example, such wearable and handheld devices may be highly portable and therefore available to the user 702 in many different scenarios, including all of the various scenarios described above with respect to the scenario classifier 304 of FIG. 3, and other scenarios. At the same time, available display areas of such devices may be limited. For example, the display area 805 of the wearable device 800 may be a relatively small display area, constrained by an overall size and form factor of the wearable device 800.

Consequently, the user 702 may benefit from use of the various summarization techniques described herein. For example, the user 702 may engage in interactions with separate speakers, such as a lecturer or a participant in a conversation. The user 702 and the separate speaker may have varying degrees of interactivity or back-and-forth, and two or more additional speakers may be present, as well.

Using described techniques, the user 702 may be provided with dynamic, real-time summarizations during all such interactions, as the interactions are happening. For example, the speaker may speak for a short time or a longer time, in conjunction with (e.g., in response to) dialogue provided by the user 702. During all such interactions, the user 702 may be provided with useful and convenient summaries of words spoken by the separate speaker(s).

For example, as shown in FIG. 8B, the display area 805 may be used to display lines of a summary, such as the summary 106 or the summary stream 134. When the summary stream 134 is provided in the display area 805, the lines of the summary may scroll through the display area 805, as new lines of the summary are received. In this way, the user 702 may be provided with contextual summaries, while still being able to interact with an external environment.

A first example implementation includes a computer program product, the computer program product being tangibly embodied on a non-transitory computer-readable storage medium and comprising instructions that, when executed by at least one computing device, are configured to cause the at least one computing device to:
process input text at a content type classifier machine learning (ML) model to obtain a content type of the input text;
process the input text and the content type at a content extractor ML model to obtain extracted content from the input text; and
process the input text, the content type, and the extracted content at a summarizer ML model to obtain a summary of the input text.

Example 2 includes the computer program product of example 1, wherein the content type and the extracted content are represented textually and concatenated for input to the summarizer ML model.

Example 3 includes the computer program product of example 1 or 2, wherein the instructions, when executed by the at least one computing device, are further configured to cause the at least one computing device to:
process the input text and the content type at a summary type classifier ML model to obtain a summary type for the summary; and
process the summary type with the input text and the content type at the content extractor ML model to obtain the extracted content.

Example 4 includes the computer program product of example 3, wherein the content type, the summary type, and the extracted content are represented textually and concatenated for input to the summarizer ML model.

Example 5 includes the computer program product of example 3 or 4, wherein the summary type is one of an abstractive, extractive, or hybrid abstractive-extractive summary type.

Example 6 includes the computer program product of example 3 or 4, wherein the summary type is classified numerically within a summary type range between extractive and abstractive summary types.

Example 7 includes the computer program product of any one of the preceding examples, wherein the content type is one of a plurality of content types defining corresponding scenarios for the input text.

Example 8 includes the computer program product of any one of the preceding examples, wherein the instructions, when executed by the at least one computing device, are further configured to cause the at least one computing device to:
provide the summary as part of a summary stream of a spoken conversation from which the input text is transcribed.

Example 9 includes the computer program product of any one of the preceding examples, wherein the instructions, when executed by the at least one computing device, are further configured to cause the at least one computing device to:
render the summary on a display of a head-mounted device (HMD).

Example 10 includes the computer program product of any one of the preceding examples, wherein the instructions, when executed by the at least one computing device, are further configured to cause the at least one computing device to:
train the summarizer ML model using training data that includes training input text, training content types, and training extracted content.

An eleventh example implementation includes a device comprising:
at least one memory;
at least one processor;
at least one display; and
a rendering engine including instructions stored using the at least one memory, which, when executed by the at least one processor, causes the device to
   process input text at a content type classifier machine learning (ML) model to obtain a content type of the input text;
   process the input text and the content type at a content extractor ML model to obtain extracted content from the input text; and
   process the input text, the content type, and the extracted content at a summarizer ML model to obtain a summary of the input text.

Example 12 includes the device of example 11, wherein the content type and the extracted content are represented textually and concatenated for input to the summarizer ML model.

Example 13 includes the device of example 11 or 12, wherein the instructions, when executed by the at least one processor, are further configured to cause the device to: process the input text and the content type at a summary type classifier ML model to obtain a summary type for the summary; and
process the summary type with the input text and the content type at the content extractor ML model to obtain the extracted content.

Example 14 includes the device of example 13, wherein the content type, the summary type, and the extracted content are represented textually and concatenated for input to the summarizer ML model.

Example 15 includes the device of any one of examples 11 to 14, wherein the instructions, when executed by the at least one processor, are further configured to cause the device to:
provide the summary as part of a summary stream of a spoken conversation from which the input text is transcribed.

Example 16 includes the device of any one of examples 11 to 15, wherein the device includes a head-mounted device (HMD), and wherein the instructions, when executed by the at least one processor, are further configured to cause the at least one processor to:
render the summary on a display of the HMD.

A seventeenth example includes a method comprising:
processing input text at a content type classifier machine learning (ML) model to obtain a content type of the input text;
processing the input text and the content type at a content extractor ML model to obtain extracted content from the input text; and
processing the input text, the content type, and the extracted content at a summarizer ML model to obtain a summary of the input text.

Example 18 includes the method of example 17, further comprising:
processing the input text and the content type at a summary type classifier ML model to obtain a summary type for the summary; and
processing the summary type with the input text and the content type at the content extractor ML model to obtain the extracted content.

Example 19 includes the method of example 17 or 18, wherein the content type is one of a plurality of content types defining corresponding scenarios for the input text.

Example 20 includes the method of any one of examples 17 to 20, further comprising:
providing the summary as part of a summary stream of a spoken conversation from which the input text is transcribed.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as modules, programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor, or LED (light emitting diode)) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback), and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship with each other.

In some implementations, one or more input devices in addition to the computing device (e.g., a mouse, a keyboard) can be rendered in a display of an HMD, such as the HMD 800. The rendered input devices (e.g., the rendered mouse, the rendered keyboard) can be used as rendered in the display.

A number of implementations have been described. Nevertheless, it will be understood that various modifications may be made without departing from the spirit and scope of the description and claims.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Further to the descriptions above, a user is provided with controls allowing the user to make an election as to both if and when systems, programs, devices, networks, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that user information is removed. For example, a user's identity may be treated so that no user information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The computer system (e.g., computing device) may be configured to wirelessly communicate with a network server over a network via a communication link established with the network server using any known wireless communications technologies and protocols including radio frequency (RF), microwave frequency (MWF), and/or infrared frequency (IRF) wireless communications technologies and protocols adapted for communication over the network.

In accordance with aspects of the disclosure, implementations of various techniques described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

Specific structural and functional details disclosed herein are merely representative for purposes of describing example implementations. Example implementations, however, may be embodied in many alternate forms and should not be construed as limited to only the implementations set forth herein.

The terminology used herein is for the purpose of describing particular implementations only and is not intended to be limiting of the implementations. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 130 degrees or at other orientations) and the spatially relative descriptors used herein may be interpreted accordingly.

Example implementations of the concepts are described herein with reference to cross-sectional illustrations that are schematic illustrations of idealized implementations (and intermediate structures) of example implementations. As such, variations from the shapes of the illustrations as a result, for example, of manufacturing techniques and/or tolerances, are to be expected. Thus, example implementations of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example implementations.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present implementations.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

1. A computer program product, the computer program product being tangibly embodied on a non-transitory computer-readable storage medium and comprising instructions that, when executed by at least one computing device, are configured to cause the at least one computing device to:
process input text at a content type classifier machine learning (ML) model to obtain a content type of the input text;
process the input text and the content type at a content extractor ML model to obtain extracted content from the input text; and
process the input text, the content type, and the extracted content at a summarizer ML model to obtain a summary of the input text.

2. The computer program product of claim 1, wherein the content type and the extracted content are represented textually and concatenated for input to the summarizer ML model.

3. The computer program product of claim 1, wherein the instructions, when executed by the at least one computing device, are further configured to cause the at least one computing device to:
process the input text and the content type at a summary type classifier ML model to obtain a summary type for the summary; and
process the summary type with the input text and the content type at the content extractor ML model to obtain the extracted content.

4. The computer program product of claim 3, wherein the content type, the summary type, and the extracted content are represented textually and concatenated for input to the summarizer ML model.

5. The computer program product of claim 3, wherein the summary type is one of an abstractive, extractive, or hybrid abstractive-extractive summary type.

6. The computer program product of claim 3, wherein the summary type is classified numerically within a summary type range between extractive and abstractive summary types.

7. The computer program product of claim 1, wherein the content type is one of a plurality of content types defining corresponding scenarios for the input text.

8. The computer program product of claim 1, wherein the instructions, when executed by the at least one computing device, are further configured to cause the at least one computing device to:
provide the summary as part of a summary stream of a spoken conversation from which the input text is transcribed.

9. The computer program product of claim 1, wherein the instructions, when executed by the at least one computing device, are further configured to cause the at least one computing device to:
render the summary on a display of a head-mounted device (HMD).

10. The computer program product of claim 1, wherein the instructions, when executed by the at least one computing device, are further configured to cause the at least one computing device to:
train the summarizer ML model using training data that includes training input text, training content types, and training extracted content.

11. A device comprising:
at least one memory;
at least one processor;
at least one display; and
a rendering engine including instructions stored using the at least one memory, which, when executed by the at least one processor, causes the device to
process input text at a content type classifier machine learning (ML) model to obtain a content type of the input text;
process the input text and the content type at a content extractor ML model to obtain extracted content from the input text; and
process the input text, the content type, and the extracted content at a summarizer ML model to obtain a summary of the input text.

12. The device of claim 11, wherein the content type and the extracted content are represented textually and concatenated for input to the summarizer ML model.

13. The device of claim 11, wherein the instructions, when executed by the at least one processor, are further configured to cause the device to:
process the input text and the content type at a summary type classifier ML model to obtain a summary type for the summary; and
process the summary type with the input text and the content type at the content extractor ML model to obtain the extracted content.

14. The device of claim 13, wherein the content type, the summary type, and the extracted content are represented textually and concatenated for input to the summarizer ML model.

15. The device of claim 11, wherein the instructions, when executed by the at least one processor, are further configured to cause the device to:
provide the summary as part of a summary stream of a spoken conversation from which the input text is transcribed.

16. The device claim 11, wherein the device includes a head-mounted device (HMD), and wherein the instructions, when executed by the at least one processor, are further configured to cause the at least one processor to:
render the summary on a display of the HMD.

17. A method comprising:
processing input text at a content type classifier machine learning (ML) model to obtain a content type of the input text;
processing the input text and the content type at a content extractor ML model to obtain extracted content from the input text; and
processing the input text, the content type, and the extracted content at a summarizer ML model to obtain a summary of the input text.

18. The method of claim 17, further comprising:
processing the input text and the content type at a summary type classifier ML model to obtain a summary type for the summary; and
processing the summary type with the input text and the content type at the content extractor ML model to obtain the extracted content.

19. The method of claim 17, wherein the content type is one of a plurality of content types defining corresponding scenarios for the input text.

20. The method of claim 17, further comprising:
providing the summary as part of a summary stream of a spoken conversation from which the input text is transcribed.
